(19) United States
(12) Patent Application Publication
(10) Pub. No.: US 2005/0045467 A1
(43) Pub. Date: Mar. 3, 2005

(54) Method for the conversion of methane into hydrogen and higher hydrocarbons using UV laser

(75) Inventors: Mohammad Ashraf Gondal, Islamabad (PK); Zain Hassan Yamani, Dhahran (SA); Abdul Rahman Al-Arfaj, Dhahran (SA); Mohammad Ashraf Ali, Hyderabad (PK); Mohamed Abdulkader Dastageer, Trivandrum (IN)

Correspondence Address: DENNISON, SCHULTZ, DOUGHERTY & MACDONALD, 1727 KING STREET, SUITE 105, ALEXANDRIA, VA, 22314, US

(73) Assignee: KING FAHD UNIVERSITY OF PETROLEUM AND MINERALS

(21) Appl. No.: 10/653,055

(22) Filed: Sep. 3, 2003

(51) Int. Cl. C01B 3/00; C07B 31/00

(52) U.S. Cl. 204/157.41; 204/157.52; 204/157.61

(57) ABSTRACT

A method for the non-oxidative conversion of methane into hydrogen, in addition to C₂ and higher hydrocarbons is disclosed. Pure methane is irradiated in a reaction zone which involves the multi-photon dissociation of methane under the influence of ultra-violet laser radiation at about 193 to about 400 nm, at room temperature and at a pressure ranging from 0.5 to 4 atmospheres. The products generated as a result of methane conversion are hydrogen and higher hydrocarbons which include ethane, ethylene, propane, propylene and isobutene. A conversion of 7-10% was achieved. The hydrogen yield achieved in one hour exposure of methane at ambient temperature and one atmosphere of pressure was 6.6 mole %.

### FIELD OF THE INVENTION

The invention relates to a method for the non-oxidative chemical conversion of methane into hydrogen and more valuable [C₂₊] hydrocarbons. Pure methane, in a reaction zone, is dissociated by irradiation with an ultraviolet laser at room temperature and at a pressure range from 0.5 to 4 atmospheres. As a result of methane conversion, hydrogen and higher hydrocarbons are formed which include ethane, ethylene, propane, propylene and isobutane. The conversion was found to increase with increasing exposure and laser energy. However, conversion decreased with increasing methane pressure inside the cell.

### BACKGROUND OF THE INVENTION AND DESCRIPTION OF PRIOR ART

The natural abundance and high energy content of methane gas encouraged researchers to focus their work on exploring ways to put this inexpensive energy source into proper use. Methane reserves are spread across the globe with the estimation of about 1.4×10¹¹ m³ available in the reserves worldwide. However, most of the reserves are located in inaccessible geographical locations posing great difficulty for transportation. Moreover, as a permanent gas, methane needs high pressure along with refrigeration for liquefying and transporting through existing oil pipelines. However, if methane is converted into some other useful hydrocarbons in liquid form, then the existing petroleum pipeline network can be utilized for transporting methane and hence the cost of transportation can be substantially brought down and the methane resource can be used.

Another important motivation for the conversion of methane into other hydrocarbons is the fact that methane is a major contributor to global warming and a hazardous green house gas. The control of global warming and the reduction of green house gases, are of imperative environmental concerns and these issues have been discussed in numerous international conferences on the environment and many protocols have been signed by world nations [UN Conference on Environment and Development (UNCED) held in Rio de Janeiro, Brazil in June 1992]. Hence, conversion of methane into useful hydrocarbon is an important move for humanity in general and industrial consumers in particular. Yet another important advantage of the conversion of methane is the generation of hydrogen, a major component of sustainable energy systems that is expected to play a key role in all sectors of the global economy in the near future. Today, hydrogen is widely used as a chemical feedstock in petrochemical, food, electronics and metallurgical industries. Moreover, higher hydrocarbons such as ethylene, propylene are used as raw materials for the production of polyethylene and polypropylene.

The conventional techniques for converting methane into higher hydrocarbons require high temperature, pressure and special catalysts. Hence, they are not cost effective. Research efforts have been directed to seek alternative techniques for the direct conversion of methane into liquid fuels, chemicals and high value hydrocarbons. At the present there are three methods of methane conversion based on photo-chemical processes. There methods use conventional UV sources (lamps), plasma and microwave in the presence of catalysts. Most of these methods are based on oxidative coupling of methane. Using UV radiation, in the presence of molybdena-silica catalyst, Suzuki et al. reported the formation of formaldehyde from photo-oxidation of methane at 463-493 K. Wada et al. reported that aldehydes can be selectively produced using a range of oxides of zinc, lithium, potassium, etc. from methane to propane at ambient to 550 K temperature using UV radiation. Hill et al. reported the conversion of methane into ethylene, ethane, hydrogen and smaller amount of C₃ and C₄ alkenes and alkanes from the photoinduced reaction of methane on the surface of molybdena-silica under UV irradiation and at temperatures of about 293 to 473 K. Although these studies have confirmed in principle that UV irradiation of alkanes and alkenes in the presence of catalysts can be applied to produce valuable hydrocarbons, still they need complicated experimental conditions such as high temperature, high pressure, and special catalysts. Such processes are described, for example, in U.S. Pat. No. 5,205,915; U.S. Pat. No. 06,500,313; U.S. Pat. No. 5,753,722; U.S. Pat. No. 5,205,915; U.S. Pat. No. 5,670,442; U.S. Pat. No. 5,414,176; U.S. Pat. No. 5,527,978; U.S. Pat. No. 5,817,904; U.S. Pat. No. 5,260,497; U.S. Pat. No. 6,077,492; U.S. Pat. No. 06,156,211; U.S. Pat. No. 4,788,372; U.S. Pat. No. 4,795,849 and other references.

### BRIEF SUMMARY OF THE INVENTION

In essences, the present invention contemplates a method for converting methane into hydrogen and/or higher hydrocarbons by providing a reactor chamber and an ultraviolet laser. A mass of methane is introduced into the reaction chamber and irradiated with the ultraviolet laser to thereby form hydrogen and/or higher hydrocarbons such as C₂, C₂, H₂ as well as atomic H and molecular hydrogen (H₂). Other examples of higher hydrocarbons include ethane, ethylene, propane, propylene and isobutene.

In the present work, a simple novel technique for methane conversion with laser excitation at room temperature and atmospheric pressure without the need for any catalyst has been developed. A laser beam of 355 nm and a specially designed reaction cell have been employed for this study. The reaction products such as CH, CH₂ and C₂H₂ as well as atomic (H) and molecular hydrogen (H₂ ) have been characterized using laser induced fluorescence technique while, the stable products have been analyzed by a gas chromatograph using a selective capillary column capable of separating and quantifying all hydrocarbons and hydrogen generated in the reaction. An overall conversion of approximately 7% of methane into ethane, ethylene, propane, propylene and isobutane was achieved using 90 mJ/pulse of laser radiation at 355 nm.

In a preferred embodiment of the invention, the methane conversion is attained with a laser beam having a wavelength of between about 157 nm to 400 nm and preferably at about 157, 193, 248 or 272 nm at room temperature and without a catalyst. With respect to room temperature, a temperature of between about 19° C. to 23° C. is preferred. However, it is believed that it is economic to conduct the process at temperatures of between about 19° C. to 25° C. and at a pressure of between about 0.5 and 4 atmospheres. Preferably, the pressure should be about 1 to 2 atmospheres and the process can be conducted without a catalyst.

In a preferred embodiment of the invention, the methane is subjected to a radiation for a period of about 6 to 60 minutes and wherein the laser energy is between about 10 and 133 milli-joules and preferably between about 60-120 milli-joules.

In a further embodiment of the invention, the composition of the reaction products are controlled as for example by regulating the laser energy in the laser beam, the pressure on the feed methane or the irradiation exposure time.

The following set of equations outline the pathways for the production of hydrocarbon and hydrogen:
CH₄+nh^{v} (UV laser)→>CH₃+H
H+H→>H₂ (Hydrogen Production)
CH₄+nh^{v} (UV laser)→>CH₂+H₂
CH₂+CH₂→>C₂H₄ (Ethane production)
C₂H₄+CH₂→>C₃H₆ (Higher Hydrocarbons).

### BRIEF DESCRIPTION OF THE DRAWINGS

FIG. 1. is a gas chromatogram of the reaction product showing the unconverted methane feed gas and higher hydrocarbons produced due to the photochemical reaction with a 355 nm wavelength UV laser radiation.

FIG. 2. is a graphical representation showing the laser energy dependence of production yield of hydrogen

FIG. 3. is a graphical representation showing the hydrogen yield (mole %) plotted versus the laser exposure time; and

FIG. 4. is a graphical representation showing the hydrogen yield (mole %) plotted versus the methane feed pressure.

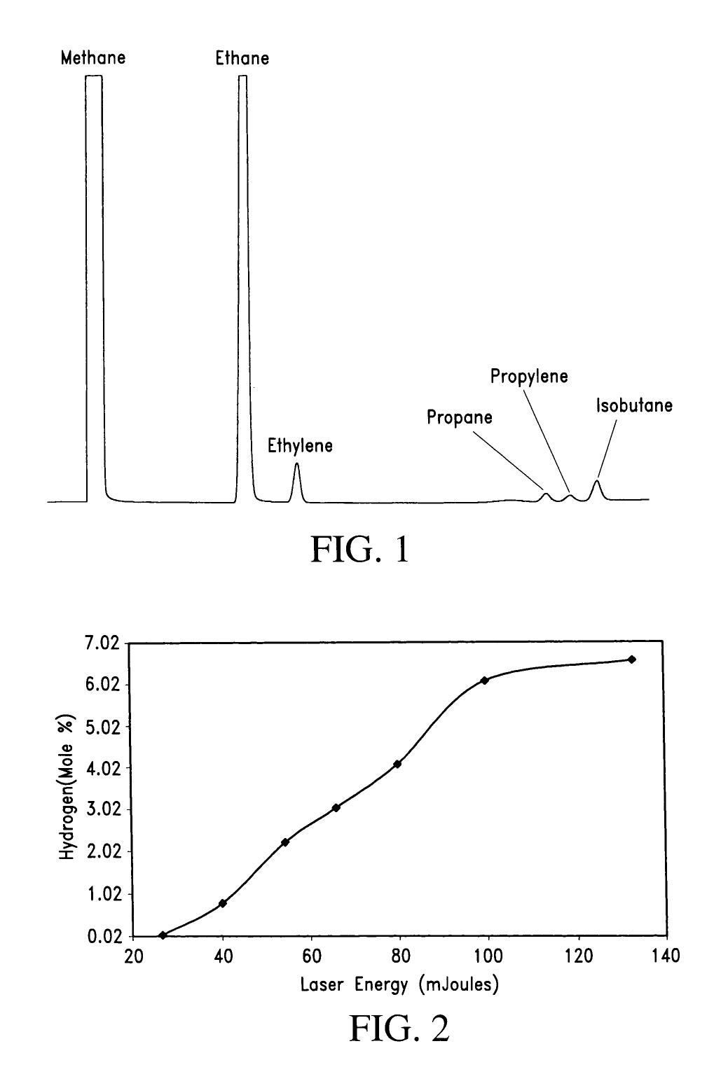

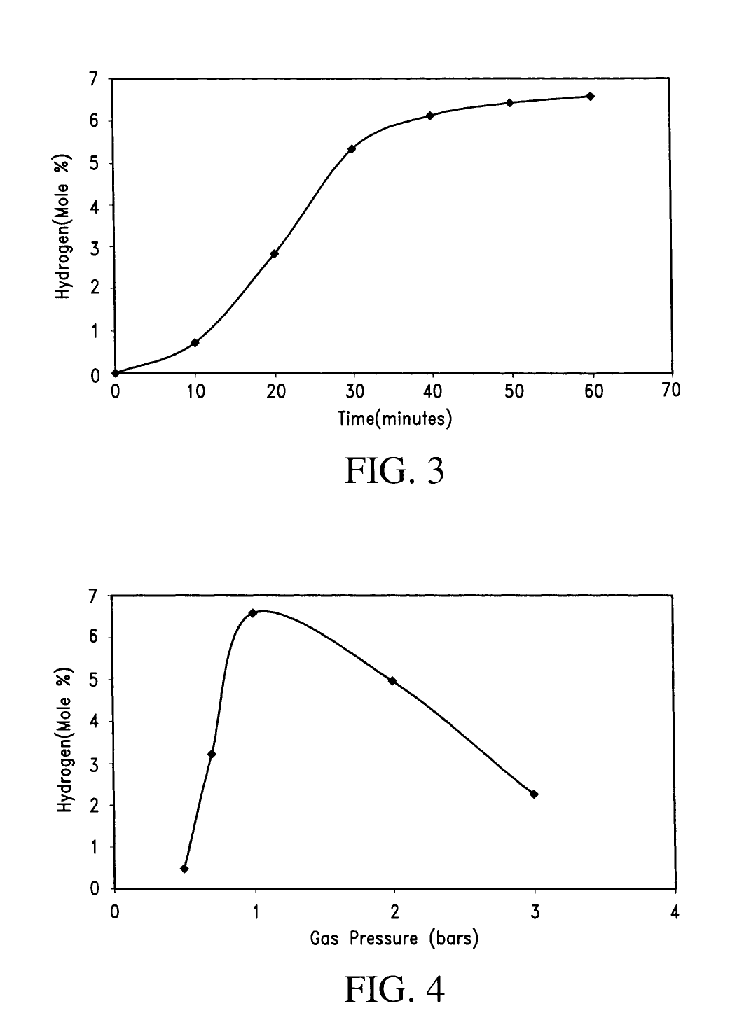

### PREFERRED EMBODIMENTS OF THE INVENTION

The main parts of the apparatus used for this invention include a stainless steal reaction chamber having optical grade quartz windows at both ends. Pressure and temperature sensors for monitoring and controlling the reaction conditions are mounted in the chamber. Analysis equipment includes a gas chromatograph. The methane gas used for these studies was high purity (99.99%) research grade. Special care was taken to avoid any form of impurities in the cell. For this purpose, leak tests over an extended time period were conducted before filling the cell which had been evacuated to a very low pressure (10⁻⁶ mbar). The excitation source, a 355 nm high power laser beam, was generated from the Q-switched third harmonic of the Spectra Physics Nd: YAG laser (Model GCR 250) with a repetition rate of 10 pulses per second. The laser beam was focused into the center of the reaction chamber using a quartz lens.

The stable products such as ethane, ethylene, propane, propylene and isobutane were characterizated using a gas chromatographic system equipped with a capillary column in a temperature programmed oven. The hydrocarbons were detected and analyzed by a flame ionization detector while hydrogen was monitored with a thermal conductivity detector. For identification and quantification of the individual components, a standard mixture of hydrocarbon gases and hydrogen was chromatographed at similar conditions prior to the analysis of the reaction products.

It is presently believed that the methane feed stock should have about 80% or greater methane and may contain other hydrocarbons such as methane and/or propane. Feed stocks may include natural gas, waste methane gas, chemical process gas, etc. It is also believed that the presence of higher hydrocarbons will enhance the process and that the presence of oxygen may result in the formation of other useful products.

In the following examples, the excitation source, a 355 nm high power laser beam was used. However, it should be recognized that the conversion method is a multi-photon conversion process. Accordingly, longer and shorter wavelength lasers can be expected to give satisfactory results, assuming that there is sufficient laser intensity. Moreover, when the laser wavelength approaches 272 nm i.e., the resonance wavelength for the C—H bond, the conversion process should be enhanced. Examples of other lasers that should convert methane to higher hydrocarbons include ArF eximer lasers (193 nm) and KrF excimer lasers (248 nm) in addition to the fourth harmonic of the Nd-YAG (266 nm) laser.

It is also believed that the use of elevated temperatures may make the process more effective. However, it is questioned if the cost of elevating the temperature and perhaps use of a catalyst would be economically justifiable. Accordingly, it is presently believed that a temperature range of about 19° C. to about 100° C. is preferred and that a room temperature of about 19° C. to 25° C. would not only be satisfactory but economical.

### EXAMPLE 1

### Effect of Laser Power on Hydrocarbons Production

This example illustrates the effect of incident laser power on hydrocarbon production for the non-oxidative conversion of methane into C₂ and higher hydrocarbons in which pure methane is irradiated in a reaction zone. The methane gas used for this study was high purity (99.99%) research grade. Special care was taken to avoid any form of impurities in the cell and for this purpose, leak tests over an extended time period were conducted before filling the cell which had been evacuated to a very low pressure (10⁻⁶ mbar). The excitation source, a 355 nm high power laser beam was generated from the third harmonic of the Spectra Physics Nd: YAG laser (Model GCR 250). The laser beam was focused into the center of the reaction chamber using a quartz lens. The laser energy per pulse was 60 milli-joules to 120 milli-joules. The stable reaction products were characterizated using a gas chromatographic system equipped with a capillary column in a temperature programmed oven. The hydrocarbons were detected and analyzed by a flame ionization detector while hydrogen was monitored using a thermal conductivity detector. The products include ethane, ethylene, propane, propylene and isobutane. Table 1 shows the composition of the reaction products (vol %) for different components at different laser energies:

TABLE 1
Composition of reaction products (vol %)
produced at different laser energies.

| | mJ/Pulse | mJ/Pulse | mJ/Pulse | mJ/Pulse | mJ/Pulse |
|---|---|---|---|---|---|
| Hydrocarbon | 60 | 80 | 90 | 100 | 120 |
| Methane | 96.391 | 94.973 | 92.799 | 94.053 | 97.370 |
| Ethane | 3.258 | 4.517 | 6.239 | 4.956 | 1.759 |
| Ethylene | 0.090 | 0.161 | 0.261 | 0.378 | 0.145 |
| Propane | 0.025 | 0.070 | 0.083 | 0.071 | 0.097 |
| Propylene | 0.016 | 0.033 | 0.016 | 0.071 | 0.051 |
| Isobutane | 0.220 | 0.246 | 0.297 | 0.404 | 0.459 |

### EXAMPLE 2

### Effect of Methane Gas Pressure on Hydrocarbons Production

This example illustrates the effect of methane gas pressure on hydrocarbon production for the non-oxidative conversion of methane into C₂ and higher hydrocarbons in which pure methane is irradiated in a reaction zone by filling the cell at different methane gas pressures. The laser energy and the exposure time during this study were kept constant and the only variable was the gas pressure. Table 2 gives the composition of reaction products (vol %) for different components at different gas pressures.

The methane gas used for this study was high purity (99.99%) research grade. Special care was taken to avoid any form of impurities in the cell and for this purpose; the leak tests over an extended time period were conducted before filling the cell, which had been evacuated to a very low pressure (10⁻⁶ mbar). The excitation source, 355 nm high power laser beam was generated from the third harmonic of the Spectra Physics Nd: YAG laser (Model GCR 250). The laser beam was focused into the center of the reaction chamber using a quartz lens. The laser energy and the exposure time during this study were kept constant and the only variable was the gas pressure. The stable reaction products were characterizated using a gas chromatographic system equipped with a capillary column in a temperature-programmed oven. The hydrocarbons were detected and analyzed by a flame ionization detector. The products include ethane, ethylene, propane, propylene and isobutane. Table 2 gives the composition of the reaction products in volume percent for different components at different pressures of the methane feed gas.

TABLE 2
Composition of reaction products (vol %) at different pressure
of methane feed gas at laser energy of 70 mJ.

| | 1 | 2 | 4 |
|---|---|---|---|
| Hydrocarbon | Atmosphere | atmospheres | atmospheres |
| Methane | 95.68 | 97.59 | 98.396 |
| Ethane | 3.8875 | 1.61 | 1.352 |
| Ethylene | 0.125 | 0.071 | 0.04 |
| Propane | 0.048 | 0.159 | 0.121 |
| Propylene | 0.025 | 0.34 | 0.014 |
| Isobutane | 0.233 | 0.156 | 0.006 |

### EXAMPLE 3

### Effect of Exposure Time on Hydrocarbon Production

This example illustrates the effect of laser exposure time on hydrocarbon production for the non-oxidative conversion of methane into C₂ and higher hydrocarbons in which pure methane is irradiated in a reaction zone. The methane gas used for this study was high purity (99.99%) research grade. Special care was taken to avoid any form of impurities in the cell and for this purpose; leak tests over an extended time period were conducted before filling the cell, which had been evacuated to a very low pressure (10⁻⁶ mbar). The excitation source, 355 nm high power laser beam was generated from the third harmonic of the Spectra Physics Nd: YAG laser (Model GCR 250). The laser beam was focused into the center of the reaction chamber using a quartz lens. The laser energy and the methane gas pressure during this study were kept constant and only the exposure time interval was varied. The stable reaction products were characterized using a gas chromatographic system equipped with a capillary column in a temperature-programmed oven. The hydrocarbons were detected and analyzed by a flame ionization detector. The products include ethane, ethylene, propane, propylene and isobutane. Table 3 gives the composition of the reaction products in volume percent for different components for different laser exposure time intervals.

TABLE 3
Composition of reaction products (vol %) at different laser exposure
times. The operating conditions used were laser energy of 70 mJ and
a feed gas pressure of 1 atmosphere.

| | 20 | 50 |
|---|---|---|
| Hydrocarbon | Minutes | Minutes |
| Methane | 97.204 | 96.50 |
| Ethane | 2.557 | 3.036 |
| Ethylene | 0.067 | 0.111 |
| Propane | 0.018 | 0.206 |
| Propylene | 0.012 | 0.11 |
| Isobutane | 0.143 | 0.156 |

### EXAMPLE 4

### Effect of Laser Power on Hydrogen Production

This example illustrates the dependence of the hydrogen production on incident laser power for the conversion of methane into hydrogen in which pure methane is irradiated in a reaction zone. The methane gas used for this study was high purity (99.99%) research grade. Special care was taken to avoid any form of impurities in the cell and for this purpose, leak tests over an extended time period were conducted before filling the cell which had been evacuated to a very low pressure (10⁻⁶ mbar). The excitation source, a 355 nm high power laser beam was generated from the third harmonic of the Spectra Physics Nd: YAG laser (Model GCR 250). The laser beam was focused into the center of the reaction chamber using a quartz lens. The laser energy per pulse was varied from 20 milli-joules to 133 milli-joules. The Hydrogen produced during the reaction was characterizated using a gas chromatographic system equipped with a capillary column in a temperature programmed oven. The methane gas was exposed to laser radiation for a period of 60 minutes and exposure time was kept constant throughout this study. The hydrogen yield was monitored using a thermal conductivity detector. Results from these studies are summarized in Table 4.

TABLE 4
Mole Percent Hydrogen produced at different laser energies

| Laser Energy | Mole % |
|---|---|
| 0 | 0 |
| 26.66 | 0.05 |
| 40 | 0.796 |
| 54.4 | 2.23 |
| 66 | 3.045 |
| 80 | 4.08 |
| 100 | 6.09 |
| 133 | 6.58 |

### EXAMPLE 5

### Effect of Exposure Time on Hydrogen Production

This example illustrates the effect of laser exposure time on hydrogen production for the non-oxidative conversion of methane into hydrogen in which pure methane is irradiated in a reaction zone. The methane gas used for this study was high purity (99.99%) research grade. Special care was taken to avoid any form of impurities in the cell and for this purpose; the leak tests over an extended time period were conducted before filling the cell, which has been evacuated to a very low pressure (10⁻⁶ mbar). The excitation source, a 355 nm high power laser beam was generated from the third harmonic of the Spectra Physics Nd: YAG laser (Model GCR 250). The laser beam was focused into the center of the reaction chamber using a quartz lens. The laser energy and the methane gas pressure during this study were kept constant and only the exposure time interval was varied. The Hydrogen produced during the reaction was characterized using a calibrated gas chromatographic system equipped with a capillary column in a temperature programmed oven. The hydrogen yield was monitored using a thermal conductivity detector. Results are presented in Table 5.

TABLE 5
Mole Percent Hydrogen produced at different laser exposure
times. The operating conditions used were laser energy of
133 mJ and a feed gas pressure of 1 atmosphere.

| Laser Exposure | Mole % |
|---|---|
| 0 | 0 |
| 10 | 0.72 |
| 20 | 2.829 |
| 30 | 5.338 |
| 40 | 6.128 |
| 50 | 6.425 |
| 60 | 6.583 |

### EXAMPLE 6

### Effect of Methane Gas Pressure on Hydrogen Production

This example illustrates the effect of methane gas pressure on hydrogen production for the non-oxidative conversion of methane into hydrogen in which pure methane is irradiated in a reaction zone by filling cell with different methane gas pressures. The laser energy and the exposure time during this study were kept constant and only variable was the gas pressure. Table 6 gives the Mole percent for hydrogen produced at different methane gas pressures. The methane gas used for this study was high purity (99.99%) research grade. Special care was taken to avoid any form of impurities in the cell and for this purpose; the leak tests over an extended time period were conducted before filling the cell, which has been evacuated to a very low pressure (10⁻⁶ mbar). The excitation source, a 355 nm high power laser beam was generated from the third harmonic of the Spectra Physics Nd: YAG laser (Model GCR 250). The laser beam was focused into the center of the reaction chamber using a quartz lens. The laser energy and the exposure time during this study were kept constant and only variable was the gas pressure. The Hydrogen produced during the reaction was characterized using a gas chromatographic system equipped with a capillary column in a temperature programmed oven. The hydrogen yield was monitored using a thermal conductivity detector. Results from these studies are presented in Table 5 for different pressure of methane feed gas.

TABLE 6
Mole Percent of Hydrogen produced at different pressure of
methane feed gas at laser energy of 133 mJ.

| Methane Gas | Mole % |
|---|---|
| 0 | 0 |
| 0.5 | 0.477 |
| 0.7 | 3.225 |
| 1 | 6.579 |
| 2 | 4.966 |
| 3 | 2.257 |

While the invention has been described in connection with its preferred embodiments, it should be recognized that changes and modifications may be made therein without departing from the scope of the appended claims.

1. A method for the conversion of methane into hydrogen and/or higher hydrocarbons by the multiphoton disassociation of methane under the influence of an ultraviolet laser and a pressure ranging from about 0.5 to about 4 atmospheres.

2. A method for the conversion of methane into hydrogen and/or higher hydrocarbons according to claim 1, in which the multiphoton disassociation is done at a temperature of between about 19° C. to 100° C.

3. A method for the conversion of methane into hydrogen and/or higher hydrocarbons according to claim 1, in which the methane is about 80% pure and in which the irradiation of the methane is done with UV light of between about 157 nm and about 400 nm.

4. A method for the conversion of methane into hydrogen and/or higher hydrocarbons according to claim 1, in which the pressure ranges between 1 and 2 atmospheres.

5. A method for the conversion of methane into hydrogen and/or higher hydrocarbons according to claim 3, in which the methane is subjected to a laser energy per pulse of between about 60 milli-joules to about 120 milli-joules.

6. A method for the conversion of methane into hydrogen and/or higher hydrocarbons according to claim 5, in which the methane is subjected to irradiation for a period of 6 to 60 minutes.

7. A method for the conversion of methane into hydrogen and/or higher hydrocarbons according to claim 6, in which the methane is subjected to irradiation for a period of about 20 to about 60 minutes.

8. A process for the non-oxidative coupling of methane to form hydrogen and higher hydrocarbons comprising the steps of:
providing a reaction chamber and an ultraviolet laser;
introducing a mass of methane into the reaction chamber; and
irradiating the methane in the reaction chamber with the ultraviolet laser to thereby form hydrogen and higher hydrocarbons.

9. A process for the non-oxidative coupling of methane to form hydrogen and higher hydrocarbons according to claim 8, which includes the step of purging the reaction chamber of oxygen prior to introducing the mass of methane into the reaction chamber.

10. A process for the non-oxidative coupling of methane to form hydrogen and higher hydrocarbons according to claim 9, in which relatively pure methane is introduced into the reaction chamber and in which the methane is irradiated with UV light at a wavelength of between about 272 nm and 355 nm.

11. A process for the non-oxidative coupling of methane to form hydrogen and higher hydrocarbons according to claim 10, in which the methane is irradiated by an ultraviolet laser producing a beam of radiation with a wavelength of about 272 nm.

12. A process for the non-oxidative coupling of methane to form hydrogen and higher hydrocarbons according to claim 10, in which the methane is irradiated with a beam of radiation having a wavelength of about 355 nm.

13. A process for the non-oxidative coupling of methane to form hydrogen and higher hydrocarbons according to claim 10, in which the pressure in the chamber is maintained at a pressure of between about 0.5 to 2 atmospheres.

14. A process for the non-oxidative coupling of methane to form hydrogen and higher hydrocarbons according to claim 13, in which the methane is irradiated at a temperature of about 19° C. to 25° C.

15. A process for the non-oxidative coupling of methane to form hydrogen and higher hydrocarbon according to claim 9, in which the reaction chamber is purged by reducing the pressure to about 10⁻⁶ mbar.

16. A process for the non-oxidative coupling of methane to form hydrogen and higher hydrocarbon according to claim 8, in which the reaction chamber includes a body of stainless steel with optical grade quartz windows on both ends.

17. A method for the conversion of methane into hydrogen and/or higher hydrocarbons comprising the steps of:
providing a reaction chamber and an ultraviolet laser;
introducing methane into the reaction chamber;
irradiating the methane in the reaction chamber with the ultraviolet laser; and
controlling the composition of the reaction products.

18. A method for the conversion of methane into hydrogen and/or higher hydrocarbons according to claim 17 in which the composition of the reaction products is controlled by regulating the laser energy in irradiating the methane.

19. A method for the conversion of methane into hydrogen and/or high hydrocarbons according to claim 17, in which the composition of the reaction products in Vol. % is controlled by the pressure on the methane.

20. A method for the conversion of methane into hydrogen and/or high hydrocarbons according to claim 17, in which the amount of hydrogen produced is controlled by the laser energy and wherein the laser energy is between about 10 and 133 milli-joules.

21. A method for the conversion of methane into hydrogen and/or high hydrocarbons according to claim 17, in which the composition of the reaction product is controlled by the irradiation exposure time.

22. A method for the conversion of methane into hydrogen and/or higher hydrocarbons according to claim 17 in which the yield is enhanced by the use of a catalyst and by temperature control.
